(19) United States
(12) Patent Application Publication
(10) Pub. No.: US 2026/0074232 A1
(43) Pub. Date: Mar. 12, 2026

(54) CAPACITOR-ASSISTED CURRENT COLLECTOR

(71) Applicant: GM Global Technology Operations LLC, Detroit, MI (US)

(72) Inventors: Dewen Kong, Shanghai (CN); Haijing Liu, Shanghai (CN); Meiyuan Wu, PUDONG (CN)

(21) Appl. No.: 18/887,574

(22) Filed: Sep. 17, 2024

(30) Foreign Application Priority Data
Sep. 10, 2024 (CN) 202411265985.0

(51) Int. Cl. H01M 4/66; H01M 4/04; H01M 4/62

(52) U.S. Cl. CPC H01M 4/667; H01M 4/0404; H01M 4/622; H01M 4/625; H01M 4/661

(57) ABSTRACT

A battery for a vehicle battery pack, a capacitor-assisted current collector, and a method is provided. The vehicle battery pack includes a battery pack housing and at least one vehicle battery cell carried by the battery pack housing. The at least one vehicle battery cell includes a cathode, an anode, a separator, and an electrolyte. The at least one vehicle battery cell further includes a current collector and a multi-functional coating layer disposed on and adhered to at least one side of the current collector. The multi-functional coating layer is configured to provide fast charge capability for the vehicle battery pack. The multi-functional coating layer includes a capacitor material configured to enhance pulsed and continuous charge rate capability, a conductive filler configured to provide electrical conductivity, and a binder configured to provide adhering capability between the multi-functional coating layer and the current collector.

### INTRODUCTION

The present disclosure relates to vehicles, and more particularly, to a current collector in a vehicle battery system.

Electric-powered automotive vehicles use multi-cell batteries to provide electrical energy for providing electrical power for driving the vehicle and for providing electrical energy to many devices on the vehicle. Batteries comprising many lithium-ion electrochemical cells are examples of such electrical power sources.

In some applications it may be useful to combine a lithium-ion battery with a capacitor. Such capacitors may be charged during braking of the vehicle. The resulting stored electrical charge can be used in recharging cells of the lithium-ion battery. Capacitors can provide fast charge capacity of the lithium-ion battery cells.

While prior art methods and systems attempt to charge lithium-ion battery cells with capacitors and may achieve their particular purpose, a need still exists for new and improved battery charging.

### SUMMARY

According to several aspects of the present disclosure, a vehicle battery pack having a capacitor-assisted current collector is provided. The vehicle battery pack includes a battery pack housing and at least one vehicle battery cell carried by the battery pack housing. The at least one vehicle battery cell includes a cathode, an anode, a separator, and an electrolyte. The at least one vehicle battery cell further includes a current collector and a multi-functional coating layer disposed on and adhered to at least one side of the current collector. The multi-functional coating layer is configured to provide fast charge capability for the vehicle battery pack. The multi-functional coating layer includes a capacitor material configured to enhance pulsed and continuous charge rate capability, a conductive filler configured to provide electrical conductivity, and a binder configured to provide adhering capability between the multi-functional coating layer and the current collector.

In accordance with another aspect of the disclosure, the vehicle battery pack having a capacitor-assisted current collector includes a current collector having an aluminum foil having a thickness of about 10 microns.

In accordance with another aspect of the disclosure, the vehicle battery pack having a capacitor-assisted current collector includes a capacitor material disposed on and adhered to the current collector in a wave configuration and rivet interface, which provides adhesion force.

In accordance with another aspect of the disclosure, the vehicle battery pack having a capacitor-assisted current collector includes a capacitor material in an intaglio printed configuration on the current collector.

In accordance with another aspect of the disclosure, the vehicle battery pack having a capacitor-assisted current collector includes a multi-functional coating layer with a thickness between about 4 and about 30 microns.

In accordance with another aspect of the disclosure, the vehicle battery pack having a capacitor-assisted current collector includes a capacitor material that is spherical with about a one micron diameter.

In accordance with another aspect of the disclosure, the vehicle battery pack having a capacitor-assisted current collector includes a multi-functional coating layer having a planar surface with a thickness of between about 0.5 microns and 20 microns.

In accordance with another aspect of the disclosure, the vehicle battery pack having a capacitor-assisted current collector includes a multi-functional coating layer with a carbon layer disposed on the current collector and a capacitor layer disposed on the carbon layer.

In accordance with another aspect of the disclosure, the vehicle battery pack having a capacitor-assisted current collector includes a multi-functional coating layer between about 40-80 weight % active carbon, between about 18-40 weight % conductive carbon, and between about 2-20 weight % binder.

In accordance with another aspect of the disclosure, the vehicle battery pack having a capacitor-assisted current collector includes a multi-functional coating layer with a dispersion agent including at least one of polyvinyl alcohol (PVA) or polyvinylpyrrolidone (PVP), and the dispersion agent is between about 0.1-5 weight % of the multi-functional coating layer.

In accordance with another aspect of the disclosure, the vehicle battery pack having a capacitor-assisted current collector includes a multi-functional coating layer with a mass loading between about 0.01-1 milligrams per square centimeter.

In accordance with another aspect of the disclosure, the vehicle battery pack having a capacitor-assisted current collector includes a capacitor material including at least one of carbon, metal oxide, or a polymer.

In accordance with another aspect of the disclosure, the vehicle battery pack having a capacitor-assisted current collector includes a conductive filler including at least one of carbon black, graphite, graphene, graphene oxide, Super P, acetylene black, Ketjen black, single-walled carbon nanotubes (SWCNTs), multi-walled carbon nanotubes (MWCNTs), or oxides, the oxides including at least one of a simple oxide, a superconductive oxide, a carbide, or a silicide.

In accordance with another aspect of the disclosure, the vehicle battery pack having a capacitor-assisted current collector includes a binder including at least one of polyacrylic acid (PAA), carboxymethyl cellulose (CMC)/styrene butadiene rubber (SBR), polyacrylonitrile (PAN), polyvinylidene fluoride (PVDF), or N-Methyl-2-pyrrolidone (NMP).

In accordance with another aspect of the disclosure, the vehicle battery pack having a capacitor-assisted current collector includes a current collector formed from at least one of a solid metal foil, a meshed foil, or a three dimensional foam composite.

In accordance with another aspect of the disclosure, the vehicle battery pack having a capacitor-assisted current collector includes a current collector formed from at least one of aluminum or copper.

According to several aspects of the present disclosure, a capacitor-assisted current collector is provided. The capacitor-assisted current collector includes a current collector and a multi-functional coating layer adhered to at least one side of the current collector. The multi-functional coating layer is configured to provide fast charge capability for a vehicle battery pack. The multi-functional coating layer includes a capacitor material configured to enhance pulsed and continuous charge rate capability, a conductive filler configured to provide electrical conductivity, and a binder configured to provide adhering capability between the multi-functional coating layer and the current collector.

According to several aspects of the present disclosure, a method for forming a capacitor-assisted current collector is provided. The method includes mixing a first slurry using a solvent and intaglio printing the first slurry on an aluminum current collector. The first slurry includes a conductive carbon. The method also includes drying the first slurry using a heater to form a dried first slurry layer and multi-functional coating layer. A solid content of the multi-functional coating layer is about 20 weight %, and the multi-functional coating layer is configured to provide fast charge capability for a vehicle battery pack.

In accordance with another aspect of the disclosure, the method includes a first slurry including the conductive carbon, a conductive filler, and a binder.

In accordance with another aspect of the disclosure, the method further includes mixing a second slurry including an active carbon, coating the dried first slurry layer with the second slurry, drying the second slurry to form a capacitor layer.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having a battery pack including battery cells with a capacitor-assisted current collector, in accordance with the present disclosure.

FIG. 2 is a cross section view illustrating a capacitor-assisted current collector in the vehicle battery pack shown in FIG. 1, where the capacitor-assisted current collector has an intaglio printed multi-functional coating layer, in accordance with the present disclosure.

FIG. 3 is a cross section view illustrating a capacitor-assisted current collector in the vehicle battery pack shown in FIG. 1, where the capacitor-assisted current collector has spherical capacitor material embedded within the multi-functional coating layer, in accordance with the present disclosure.

FIG. 4 is a cross section view illustrating a capacitor-assisted current collector in the vehicle battery pack shown in FIG. 1, where the capacitor-assisted current collector has a multi-functional coating layer including a carbon layer and a capacitor layer disposed on the carbon layer, in accordance with the present disclosure.

FIG. 5 is a flowchart illustrating a method for forming the capacitor-assisted current collector as shown in FIGS. 2 through 4, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

A vehicle battery pack is disclosed herein that includes a capacitor-assisted current collector. The capacitor-assisted current collector has a multi-functional coating layer with specific designs for ultrafast charging capability and for being suitable for use in high power cells.

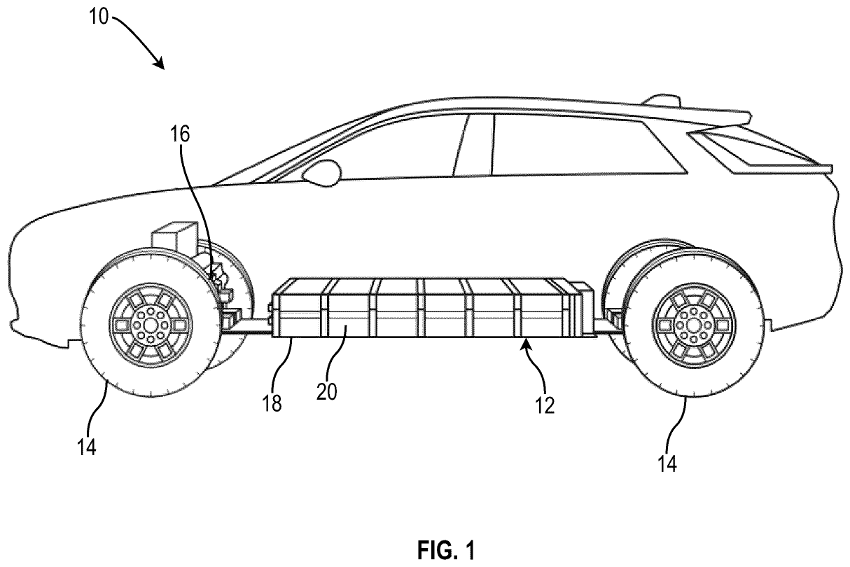

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 16. The electric motors/inverters 16 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a housing 18 for carrying and supporting a plurality of battery cells 20. In an example, the battery pack 12 may have fifty or more battery cells 20. Each battery cell 20 includes a cathode electrode (not shown), an anode electrode (not shown), a separator (not shown), and an electrolyte (not shown).

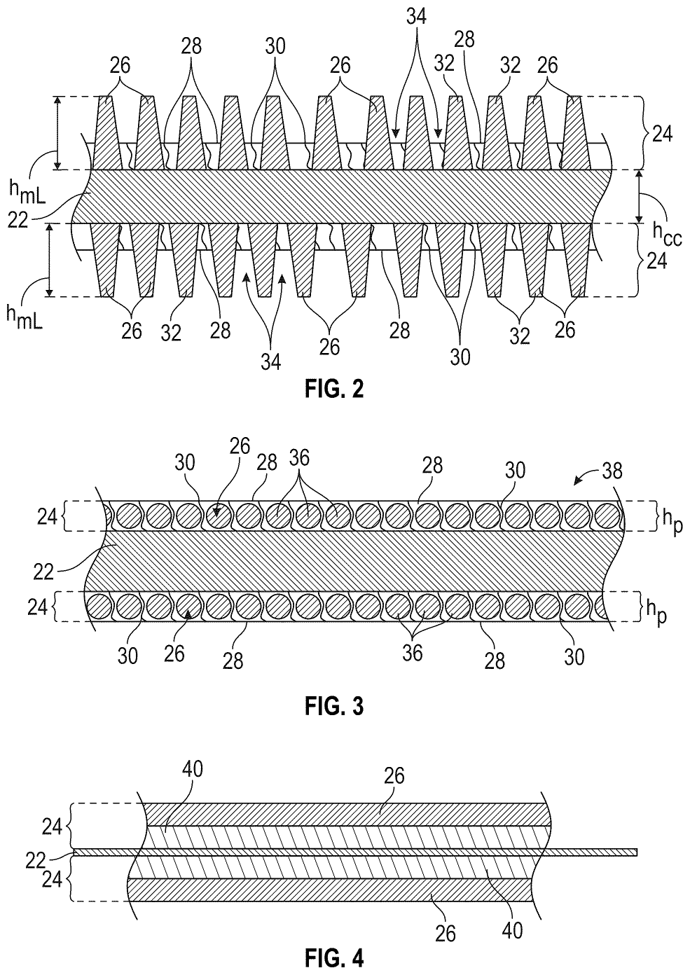

FIG. 2 illustrates a capacitor-assisted current collector 22 having a multi-functional coating layer 24, where the current collector 22 is included as part of the cathode electrode and/or the anode electrode within each battery cell 20. The current collector 22 serves a bridge function in supporting active material, for example active cathode and anode materials, binders, and conductive additives, and electrochemically connecting overall structure of the cathodes and anodes with an external circuit. The current collector 22 may be formed of aluminum, stainless steel, copper, a three-dimensional (3D) foam composite, a composite type, or other suitable conductive materials. Further, the current collector 22 may be in the form of a solid metal foil, a meshed foil, and/or a three-dimensional (3D) composite or composite type current collector. Some examples of a 3D composite or composite-type current collector 22 may include carbon fiber and carbon nanotubes (CNTs), a polymer-carbon composite, conductive resins and carbon-coated aluminum foil, and the like. One example of a composite-type current collector 22 includes a battery collector material that has a three-layer structure made of metal, polymer, and metal (e.g., aluminum, polyethylene terephthalate (PET), aluminum). The layers may be formed by metallizing or magnetron sputtering a biaxially oriented film substrate, for example polyethylene terephthalate (PET) or polypropylene (PP), with thin-scale metal. The middle layer may also be made of polyimide (PI) or another suitable polymer or non-metal material. Additionally, the current collector 22 may have a variety of thicknesses depending on its application (e.g., 4-30 micrometers (μm)). For example, a copper current collector 22 used for an anode may be between about 4-12 μm in thickness h_{CC}. In another example, an aluminum current collector 22 used for a cathode may be between about 10-20 μm in thickness h_{CC}. In the specific example illustrated in FIG. 2, the current collector 22 is solid metal foil formed from aluminum and is about 10 μm in thickness h_{CC}. In this context, one of skill in the art would understand the meaning of the term “about.” Alternatively, the term “about” means plus or minus 0.5 μm.

The multi-functional coating layer 24 is disposed on and adhered to at least one side of the current collector 22. In FIG. 2, the multi-functional coating layer 24 is shown on two sides of the current collector 22, although in some instances, the multi-functional coating layer 24 may be disposed on only one side of the current collector 22. The multi-functional coating layer 24 is configured to provide fast charge capability for the vehicle battery pack 12. The multi-functional coating layer 24 may include a dispersion agent, for example polyvinyl alcohol (PVA) and/or polyvinylpyrrolidone (PVP). When included, the dispersion agent may be between about 0.1-5 weight % (wt. %) of the overall multi-functional coating layer 24.

The multi-functional coating layer 24 has a mass loading between about 0.01-1 milligrams per square centimeter (mg/cm²). Preferably, the multi-functional coating layer 24 has a mass loading between about 0.03-0.2 mg/cm². In this context, one of skill in the art would understand the meaning of the term “about.” Alternatively, the term “about” means plus or minus 0.01 mg/cm². Furthermore, depending on the application, the multi-functional coating layer 24 has a thickness h_{CL} between about 0.1-30 μm. Preferably, the multi-functional coating layer 24 has a thickness h_{CL} between about 1-10 μm.

The multi-functional coating layer 24 includes a capacitor layer 26, a conductive filler 28, and a binder 30. In an example, the multi-functional coating layer 24 is between about 40-80 wt. % capacitor layer 26, between about 18-40 wt. % conductive carbon, and between about 2-20 wt. % binder. In this context, one of skill in the art would understand the meaning of the term “about.” Alternatively, the term “about” means plus or minus 1 wt. %.

The capacitor layer 26 is configured to enhance pulsed and continuous charge rate capability of each battery cell 20 and the overall vehicle battery pack 12. The capacitor layer 26 may include a carbon-based material, for example activated carbon, graphene, carbon nanotubes, and the like. Preferably, the capacitor layer 26 includes activated carbon having a particle size distribution D50 between 0.5-20 μm. The term D50 refers to the median particle size in a distribution, meaning that 50% of the particles are smaller than this size and 50% are larger. More preferably, the capacitor layer 26 includes activated carbon having a particle size distribution D50 between 1-8 μm. The capacitor layer 26 may also include metal oxides, for example MOₓ, where M may be cobalt (Co), ruthenium (Ru), and/or niobium (Nb), and the like. The capacitor layer 26 may also include a polymer, for example polyaniline, polyacetylene, and the like, or a combination of the above.

The conductive filler 28 is configured to provide electrical conductivity to the capacitor-assisted current collector 22 and the vehicle battery pack 12. The conductive filler 28 may include a carbon-based material, for example carbon black, graphite, graphene, graphene oxide, Super P, acetylene black, Ketjen black, single-walled carbon nanotubes (SWCNTs), multi-walled carbon nanotubes (MWCNTs), other electronically conductive additives, or a combination thereof. The conductive filler 28 may also include oxides, for example simple oxides (e.g., ruthenium(IV) oxide (RuO₂), tin(IV) oxide (SnO₂), zinc oxide (ZnO), germanium(III) oxide (Ge₂O₃), and the like), a superconductive oxide (e.g., yttrium barium copper oxide (YBa₂Cu₃O₇), lanthanum calcium manganite (La_{0.75}Ca_{0.25}MnO₃)), a carbide (e.g., silicon dicarbide (SiC₂)), a silicide (e.g., molybdenum disilicide (MoSi₂)), or a combination thereof.

The binder 30 is configured to provide adhering capability between the multi-functional coating layer 24 and the current collector 22. The binder 30 may include an aqueous binder, for example polyacrylic acid (PAA), carboxymethyl cellulose (CMC)/styrene butadiene rubber (SBR), polyacrylonitrile (PAN), combinations thereof, and the like. The binder 30 may also include a non-aqueous binder, for example polyvinylidene fluoride (PVDF), N-Methyl-2-pyrrolidone (NMP), a combination thereof, and the like.

Still referring to FIG. 2, the multi-functional coating layer 24 has a wave configuration and rivet interface. In this configuration, the capacitor layer 26 can be intaglio printed onto the current collector 22. Intaglio printing includes using a process where an image or a design is incised, engraved, and/or etched into a surface. For example, the capacitor layer 26 can be formed by depositing a layer of active carbon onto the current collector 22 and then intaglio printed including engraving or etching a surface of the layer of active carbon to form a series of peaks 32 and valleys 34 in the capacitor layer 26. The resulting shape gives the capacitor layer 26 an intaglio printed configuration and a rivet interface, which improves adhesion force between the multi-functional coating layer 24 (e.g., the “active layer”) and the current collector 22. It should be appreciated that while the valleys 34 and peaks 32 are shown in a cross-sectional view, the valleys 34 and peaks 32 may be on an ordered fashion (e.g., rows) or may be disposed in a random fashion within the capacitor layer 26. The multi-functional coating layer 24 also includes the conductive filler 28 and binder 30 disposed in the valleys 34 of the capacitor layer 26. Because of the height of the peaks 32, the multi-functional coating layer 24 may have a thickness between about 4-30 μm, with a preferred thickness between about 5-10 μm. In this context, the term “about” will be understood by those of skill in the art. Alternatively, the term “about” means plus or minus 0.1 μm. When the configuration illustrated in FIG. 3 is used, and in one specific example, the capacitor-assisted current collector 22 has a loading of 0.069 milligrams per square centimeter (mg/cm₂) and a resistance of 0.37 ohm·cm, where a conventional carbon coated aluminum current collector has a resistance of 3.654 ohm·cm, almost 10 times greater.

FIG. 3 illustrates another example of the multi-functional coating layer 24 where the capacitor layer 26 has spherical capacitor particles 36. In this example, the spherical capacitor particles 36 are embedded within the conductive filler 28 and binder 30. The conductive filler 28 and the binder 30 fill in around the spherical capacitor layer 26 and the spherical capacitor particles 36. Because of this, the multi-functional coating layer 24 has a generally smooth and planar surface 38. The spherical capacitor particles 36 may have a variety of sizes (e.g., 0.75-3 μm). In one example, the spherical capacitor particles 36 have a D50 median particle size distribution of about one micron (μm) diameter. In this context, the term “about” is known to those of skill in the art. Alternatively, the term “about” means plus or minus 0.05 μm. The multi-functional coating layer 24 may have a variety of thicknesses h_{P} (e.g., 1-3 μm). In an example, a thickness h_{P} of the multi-functional coating layer 24 is about 1.25 μm. In this context, the term “about” is known to those of skill in the art. Alternatively, the term “about” means plus or minus 0.05 μm.

FIG. 4 illustrates the multi-functional coating layer 24 having multiple material layers disposed on the current collector 22. The multiple material layers include a carbon layer 40 (e.g., Ketjen black) disposed directly on the current collector 22 (e.g., aluminum foil) and a capacitor layer 26 (e.g., active carbon) disposed on the carbon layer 40. This example of the multi-functional coating layer 24 is formed in a two-step process using intaglio printing as described below.

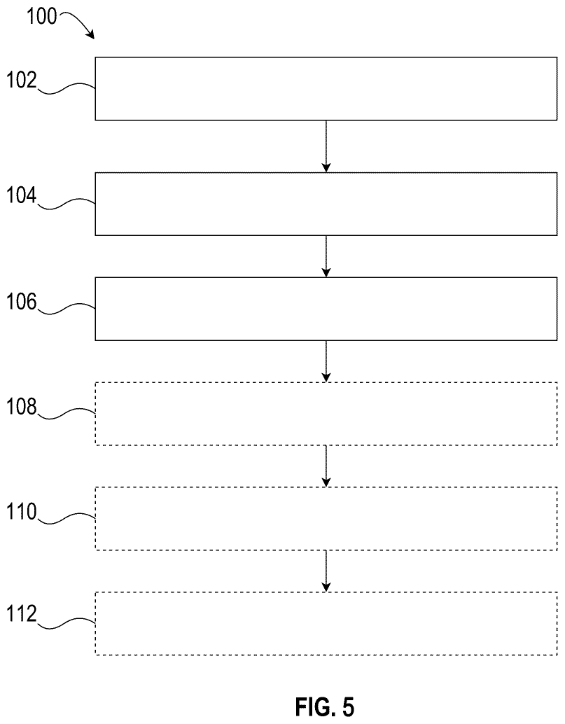

With reference to FIG. 5, a method 100 for forming a capacitor-assisted current collector is presented, in accordance with the present disclosure. The method starts at block 102. Block 102 depicts mixing a first slurry using a solvent. The first slurry includes at least a conductive carbon. In a specific example, the first slurry includes the conductive carbon, the conductive filler, and the binder. In this specific example, the slurry can include Ketjen black, a binder including polyacrylic acid (PAA), styrene butadiene rubber (SBR), and carboxymethyl cellulose (CMC), and active carbon in a 30/20/50 mass ratio. The slurry can have about a 20% solid content, although the slurry may also have other solid content percentages (e.g., 15%, 18%, 22%, 25%, and so forth). In this context, the term “about” is known to those of skill in the art. Alternatively, the term “about” means plus or minus 1%. One example of a suitable solvent includes an N-Methyl-2-pyrrolidone (NMP) solvent. Method 100 then moves to block 104.

Block 104 depicts intaglio printing the first slurry on the current collector 22. The current collector 22 can be copper and/or aluminum. The current collector 22 can be prepared using process steps like alkaline etching or applying a carbon coating. Using the intaglio printing process, the first slurry is printed and/or a design is incised, engraved, and/or etched onto the first slurry. For example, the first slurry is printed onto the current collector 22 using an intaglio printer in a certain pattern or printed and subsequently etched to have a plurality of peaks 32 and valleys 34. Using intaglio printing allows for precise control over thickness and pattern of the first slurry.

Block 106 depicts drying the first slurry. Drying the first slurry can include using a heater. Using a heater can include heating the first slurry to a specific temperature to evaporate solvents and solidify the carbon slurry. Drying the first slurry can be done in an oven or using a heat press, for example. In some instances, drying the first slurry may include using a solvent recovery system (e.g., an N-Methyl-2-pyrrolidone (NMP) solvent recovery system). Additionally, other examples of drying the first slurry may include using a UV curing process and/or using a pressure curing process. Drying the first slurry results in the multi-functional coating layer 24 disposed on and adhered to the current collector 22.

The method 100 may further include blocks 108, 110, and 112. Block 108 depicts mixing a second slurry including an active carbon. In this case, the first slurry includes a carbon, for example, Ketjen black, that forms a carbon layer 40 when dried, as illustrated in the example shown in FIG. 4. The second slurry includes, for example, activated carbon, that, when dried, forms the capacitor layer 26 as shown in FIG. 4. Mixing the second slurry may include using a solvent, for example N-Methyl-2-pyrrolidone (NMP), to form the second slurry.

Block 110 depicts coating the dried first slurry layer, or the carbon layer 40, with the second slurry. Coating the dried first slurry layer with the second slurry may include using processes such as a spray coating process, a dipping process, a slot die process, or other suitable processes.

Block 112 depicts drying the second slurry to form the capacitor layer 26. Drying the second slurry can include using a heater. Using a heater can include heating the second slurry to a specific temperature to evaporate solvents and solidify the second slurry. Drying the second slurry can be done in an oven or using a heat press, for example. In some instances, drying the second slurry may include using a solvent recovery system (e.g., an N-Methyl-2-pyrrolidone (NMP) solvent recovery system). Additionally, other examples of drying the second slurry may include using a UV curing process and/or using a pressure curing process. Drying the second slurry results in the capacitor layer 26 deposited on the carbon layer 40, which, in turn, forms the multi-functional coating layer 24 disposed on and adhered to the current collector 22.

The capacitor-assisted current collector 22 of the present disclosure is advantageous and beneficial over prior art solutions. The capacitor-assisted current collector 22 provides for ultrafast charging capability in a battery, for example an electric vehicle battery, and for being suitable for use in high power cells.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle battery pack having a capacitor-assisted current collector, comprising:
a battery pack housing; and
at least one vehicle battery cell carried by the battery pack housing, wherein the at least one vehicle battery cell includes a cathode, an anode, a separator, and an electrolyte, and wherein the at least one vehicle battery cell further includes
a current collector; and
a multi-functional coating layer disposed on and adhered to at least one side of the current collector, wherein the multi-functional coating layer is configured to provide fast charge capability for the vehicle battery pack, and wherein the multi-functional coating layer includes
a capacitor material configured to enhance pulsed and continuous charge rate capability;
a conductive filler configured to provide electrical conductivity; and
a binder configured to provide adhering capability between the multi-functional coating layer and the current collector.

2. The vehicle battery pack of claim 1, wherein the current collector includes an aluminum foil having a thickness of about 10 microns.

3. The vehicle battery pack of claim 1, wherein the capacitor material is disposed on and adhered to the current collector in a wave configuration and rivet interface, wherein the rivet interface provides adhesion force.

4. The vehicle battery pack of claim 3, wherein the capacitor material is in an intaglio printed configuration on the current collector.

5. The vehicle battery pack of claim 3, wherein the multi-functional coating layer has a thickness between about 4 and about 30 microns.

6. The vehicle battery pack of claim 1, wherein the capacitor material is spherical with about a one micron diameter.

7. The vehicle battery pack of claim 6, wherein the multi-functional coating layer has a planar surface with a thickness of between about 0.5 microns and 20 microns.

8. The vehicle battery pack of claim 1, wherein the multi-functional coating layer includes a carbon layer disposed on the current collector and a capacitor layer disposed on the carbon layer.

9. The vehicle battery pack of claim 1, wherein the multi-functional coating layer is between about 40-80 weight % active carbon, between about 18-40 weight % conductive carbon, and between about 2-20 weight % binder.

10. The vehicle battery pack of claim 1, wherein the multi-functional coating layer includes a dispersion agent including at least one of polyvinyl alcohol (PVA) or polyvinylpyrrolidone (PVP), and wherein the dispersion agent is between about 0.1-5 weight % of the multi-functional coating layer.

11. The vehicle battery pack of claim 1, wherein the multi-functional coating layer has a mass loading between about 0.01-1 milligrams per square centimeter.

12. The vehicle battery pack of claim 1, wherein the capacitor material includes at least one of carbon, metal oxide, or a polymer.

13. The vehicle battery pack of claim 1, wherein the conductive filler includes at least one of carbon black, graphite, graphene, graphene oxide, Super P, acetylene black, Ketjen black, single-walled carbon nanotubes (SWCNTs), multi-walled carbon nanotubes (MWCNTs), or oxides, the oxides including at least one of a simple oxide, a superconductive oxide, a carbide, or a silicide.

14. The vehicle battery pack of claim 1, wherein the binder includes at least one of polyacrylic acid (PAA), carboxymethyl cellulose (CMC)/styrene butadiene rubber (SBR), polyacrylonitrile (PAN), polyvinylidene fluoride (PVDF), or N-Methyl-2-pyrrolidone (NMP).

15. The vehicle battery pack of claim 1, wherein the current collector includes at least one of a solid metal foil, a meshed foil, or a three dimensional foam composite.

16. The vehicle battery pack of claim 1, wherein the current collector is formed from at least one of aluminum or copper.

17. A capacitor-assisted current collector, comprising:
a current collector; and
a multi-functional coating layer adhered to at least one side of the current collector, wherein the multi-functional coating layer is configured to provide fast charge capability for a vehicle battery pack, and wherein the multi-functional coating layer includes
a capacitor material configured to enhance pulsed and continuous charge rate capability;
a conductive filler configured to provide electrical conductivity; and
a binder configured to provide adhering capability between the multi-functional coating layer and the current collector.

18. A method for forming a capacitor-assisted current collector, comprising:
mixing a first slurry using a solvent, wherein the first slurry includes a conductive carbon;
intaglio printing the first slurry on an aluminum current collector; and
drying the first slurry using a heater to form a dried first slurry layer and multi-functional coating layer, wherein a solid content of the multi-functional coating layer is about 20 weight %, and wherein the multi-functional coating layer is configured to provide fast charge capability for a vehicle battery pack.

19. The method of claim 18, wherein the first slurry includes the conductive carbon, a conductive filler, and a binder.

20. The method of claim 18, further comprising:
mixing a second slurry including an active carbon;
coating the dried first slurry layer with the second slurry; and
drying the second slurry to form a capacitor layer.
